(19) United States
(12) Patent Application Publication
(10) Pub. No.: US 2008/0200132 A1
(43) Pub. Date: Aug. 21, 2008

(54) METHOD FOR PRODUCING LAYOUT OF SEMICONDUCTOR INTEGRATED CIRCUIT WITH RADIO FREQUENCY DEVICES

(75) Inventors: Tsun-Lai Hsu, Hsinchu Hsien (TW); Jui-Fang Chen, Miaoli County (TW); Jun-Hong Ou, Taipei City (TW); Ji-Wei Hsu, Taipei County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/675,409

(22) Filed: Feb. 15, 2007

(51) Int. Cl. H04B 1/44

(52) U.S. Cl. 455/83

(57) ABSTRACT

A method for producing an IC layout with radio frequency devices is provided. The method has following steps. Type information of at least one RF device is inputted, and at least one RF parameter corresponding to the RF device is inputted as well. A frequency response result is then generated based on the type information and the RF parameter. When the frequency response result meets the required specification, an IC layout process is performed based on the frequency response result. However, when the frequency response result doesn't meet the required specification, another RE parameter is inputted again to produce new frequency response result.

### BACKGROUND OF THE INVENTION

1. Field of the Invention

The present invention relates to a method for producing a layout of an integrated circuit (IC), and more particularly to a method for producing a layout of an integrated circuit (IC) with radio frequency (RF) devices.

2. Description of Related Art

An IC layout plays an important role in producing an integrated circuit. With the demand of reducing an IC size, it is significant to dispose most devices in a limited area and meet required specifications. However, due to the above concern of the optimization of the area, most IC layout designers at the current stage do not take the IC layout design into consideration as the RF devices e.g. a capacitor, an inductor, and a varactor are included in the IC chip.

Taking a capacitor for example, designing with a pre-simulation or a post-simulation takes too much time. If the required specifications are not satisfied, a re-design or a change of the layout design is necessary. However, from the viewpoint of efficiency and smart layout design, either the redesign or the change of the layout design is undesired.

Therefore, what is urgently needed is to develop a method, which is efficient, time-saving, and meets the required specification of designers, for producing a layout of an IC with RF devices.

In addition, taking a transformer as another example, the layout design for the transformer is based on an electromagnetic (EM) simulation. However, the EM simulation is generally taking a lot of time. Therefore, it is a good way to easily find an exact solution in short time to design the transformer layer based on the EM simulation. As a result, what is urgently needed is to develop a method, which is efficient, time-saving, and meets the required specification of designers, for creating a wide transformer library to quickly find the solution.

### SUMMARY OF THE INVENTION

In view of the above, the present invention is to provide an efficient and time-saving method for producing a layout of an IC with RF devices.

The present invention provides a method of layout for a semiconductor IC with RF devices. The method has following steps. Type of at least an RF device is inputted, and at least a RF parameter corresponding to the RF device is inputted as well. A frequency response result is then generated based on the RF parameter and the type information. When the frequency response result meets the required specification, a layout process is performed according to the frequency response result. However, when the frequency response result doesn't meet the required specification, another RE parameter is inputted again to produce new frequency response result.

According to an embodiment of the present invention, the aforesaid RF parameter comprises a device value, an operating frequency, a quality factor (a Q factor), and a combination thereof. The aforesaid RF device comprises a capacitor device, an inductor device, a varactor device, a transformer device, a resistor device, a transistor, a transformer and a combination thereof. Besides, the aforesaid type information comprises a geometric parameter of the RF device in the integrated circuit. The frequency response result at least comprises a diagram depicting the device value in response to the operating frequency and a diagram depicting the Q factor in response to the operating frequency.

According to an embodiment of the present invention, when the aforementioned RF device is a capacitor device, the type information of the capacitor device at least comprises information of a stacked type of a metal layer, a number of the stacked type, a number of fingers of the metal layer, and a length and a width of the finger. According to an embodiment of the present invention, when the RF device is an inductor device, the type information of the inductor device at least comprises a geometrical shape, a geometric dimension, a symmetric relation, and stacked type information.

Besides, according to an embodiment of the present invention, when the RF device is a resistor device, the type information of the resistor device at least comprises type information of a doped region and of a diffusion region. According to one embodiment of the present invention, when the RF device is a varactor device, the type information of the varactor device at least comprises type information of a core doped region and of an input/output doped region.

In addition, according to an embodiment of the present invention, when the RF device is a transformer device, the RF parameter of the transformer device can be at least a primary inductance, a secondary inductance, a Q factor and an operating frequency.

Through the above-mentioned embodiments, time for designers to design the layout diagram can be reduced. Through inputting the parameter of the RF device such as the operating frequency, the Q factor, and the area, the optimized device dimension and the layout design can be obtained.

In order to the make the aforementioned and other objects, features and advantages of the present invention comprehensible, a preferred embodiment accompanied with figures are described in detail below.

### BRIEF DESCRIPTION OF THE DRAWINGS

FIG. 1 is a schematic flow chart showing a layout method according to the embodiment of the present invention.

FIG. 2 is a schematic flow chart showing a layout method according to a capacitor device as the embodiment of the present invention.

FIGS. 3A and 3B are examples of FIG. 2, wherein FIG. 3A is a top view illustrating a capacitor, and FIG. 3B is a diagram depicting a frequency response of the capacitor.

FIG. 4 is a schematic flow chart showing a layout method according to an inductor device as the embodiment of the present invention.

FIGS. 5A and 5B are examples of FIG. 4, wherein FIG. 5A is a top view illustrating a spiral-like inductor device, and FIG. 5B is a diagram depicting a frequency response of the spiral-like inductor device.

FIG. 6 is a schematic flow chart showing a layout method according to a resistor device as the embodiment of the present invention.

FIG. 7 is a schematic flow chart showing a layout method according to a varactor device as the embodiment of the present invention.

FIG. 8 is a schematic flow chart showing a layout method according to a transformer device as the embodiment of the present invention.

FIG. 9 is an example of FIG. 8, and is a top view of the transformer device.

### DESCRIPTION OF EMBODIMENTS

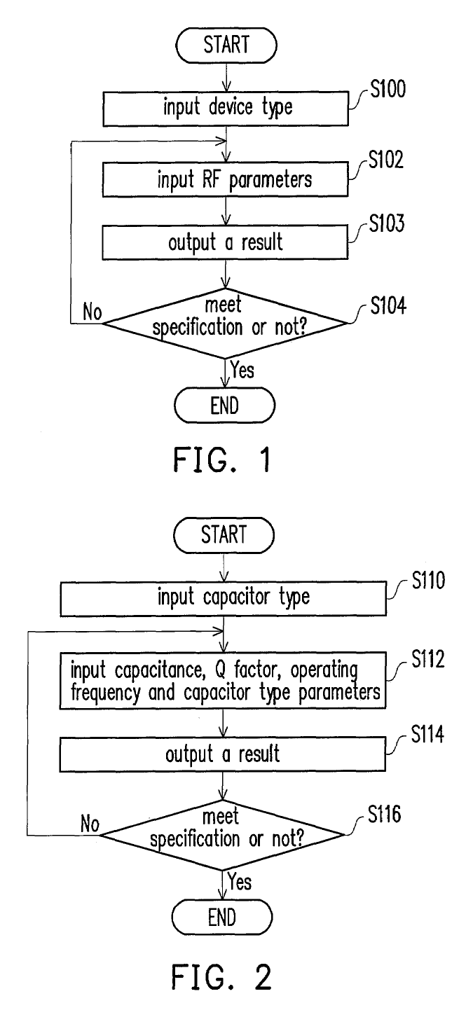

FIG. 1 is a schematic flow chart showing a layout method according to the embodiment of the present invention. First, in step S100, type information of at least one device is inputted. The device can be a capacitor device, an inductor device, a varactor device, a transformer device, or resistor and a transistor working under RF range. As for the type information of a device, the type information of the capacitor device can be stacked type information of multiple metal layers. The type information of an inductor device can be a shape of the inductor.

In step S102, after a device and required type information are inputted, at least one RF parameter corresponding to the device is inputted. The RF parameter can be an operating frequency and a corresponding Q factor. Besides, considering a frequency response of the device under the radio frequency, a value of the device itself is quite important. For example, a capacitance, an inductance, a resistance are required to be inputted. Next, in step S103, a frequency response result is generated according to the RF parameter and the type information of the device. The frequency response result mainly concerns the relation of the device value vs. the frequency and of the Q factor vs. the frequency. If the frequency response result meets the requirements, designers are capable of knowing whether the previously inputted RF parameter meets the requirements of layout design. With the results, it is convenient for designers to design or modify an IC layout.

In step S104, when the frequency response result meets the required specifications, designers can design an IC layout based on the result, so as to make the ultimate IC layout work in the best condition of an operating frequency and a Q factor. However, when the frequency response result does not meet the required specification, the design process returns to step S102 to input a RF parameter and a geometric parameter again.

From the above, the main point of the embodiment is that through inputting a RF parameter, a layout design concerns not only the geometric aspects such as an area and a layout disposition, but also the condition under an RF operation. Next, various RF devices are used as different embodiments to further explain the description of the embodiments of the present invention.

FIG. 2 is a schematic flow chart showing a layout method according to a capacitor device as the embodiment of the present invention. In step S110, the type information of the capacitor device is inputted by designers. For example, the type information can be a shape of the capacitor, a stack type of a metal layers, and a number of the stacked type of the aforesaid metal layers. That is, the required geometric structure of the capacitor in an IC design should be confirmed in the beginning. For example, a largest number of the stacked metal layers inputted by designers should be confirmed first.

Next, in step S112, RF parameters of the capacitor device are inputted, such as a capacitance, an operating frequency, a corresponding Q factor, and an area limitation. Besides, information of a bottom electrode and a top electrode of the capacitor, a largest number of the connected capacitors, a length and a width of an area, a finger number of the electrode and a length and a width of the finger are inputted. Thus, the system can proceed with calculations based on the inputted type information of the capacitor and the RF parameters to obtain a corresponding frequency response result.

The frequency response result can be, for example, the capacitance in response to the operating frequency and the Q factor in response to the operating frequency. Next, in step S114, the frequency response result is outputted for the designers. Accordingly, the designers can determine whether the inputted parameter satisfies the requirements of the IC layout and meets the required specifications.

In step S116, when the outputted result in step S114 meets the required specification, the aforesaid process is finished. On the other hand, if the outputted result in step S114 does not meet the required specification, the process will return to step S112 to input a new RF parameter and perform the aforesaid process again until a result meeting the required specification is obtained.

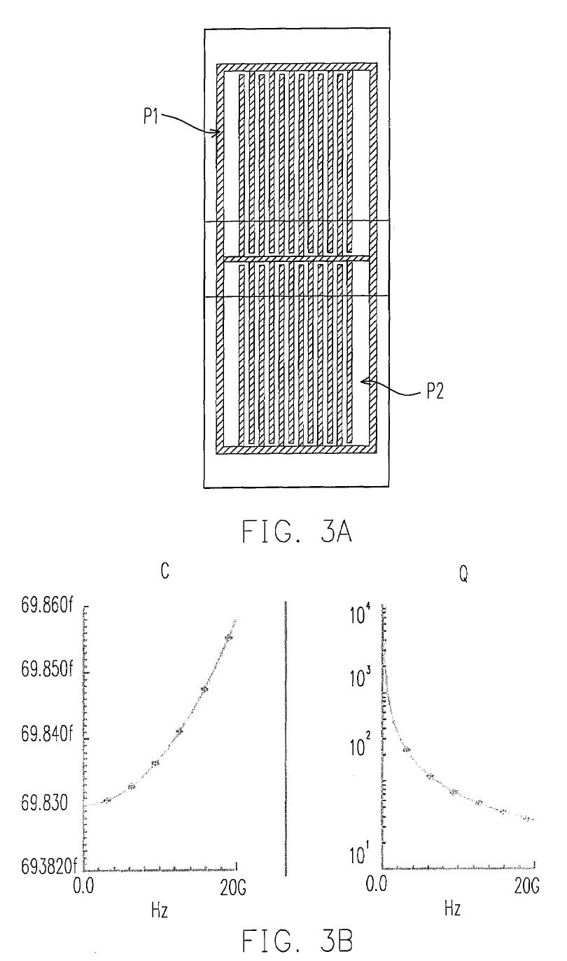

FIGS. 3A and 3B are examples of FIG. 2, wherein FIG. 3A is a top view illustrating a capacitor, and FIG. 3B is a diagram depicting a frequency response of the capacitor. In the embodiment, some geometric parameters regarding the capacitor are inputted. For example, the finger number is 12, the finger length is 5 μM, the bottom layer number is 1, the top layer number is 6, and the number of parallel-connected capacitors is 2. Next, a characteristic parameter of the capacitor is inputted. For example, the capacitance is 69.83 fF, the operating frequency Freq is 5 GHz, and the Q factor is 140.

After the process of inputting, the system performs the calculation process and a result is outputted. For example, in FIG. 3A, the capacitor structure comprises two capacitors connected in parallel each having 12 fingers. In FIG. 3B, the frequency response diagrams of capacitance vs. frequency (C vs. Freq) and Q factor vs. frequency (Q vs. Freq) are respectively shown. The result can help determine whether the required specifications are satisfied. If the result does not meet the required specifications, the parameters can be changed in the process of FIG. 3 to input parameters and perform the process again.

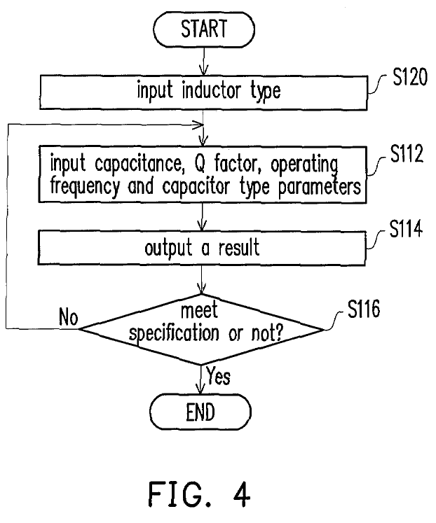

FIG. 4 is a schematic flow chart showing a layout method according to an inductor device as the embodiment of the present invention. In step S120, type information of the inductor is inputted by designers. For example, a shape of the inductor can be spiral, winding, saw-tooth, and square voltage shape. Whether the shape of the inductor is symmetric or whether the inductor is a stacked structure are taken into consideration. That is, the required geometric structure of the inductor in an IC design should be confirmed in the beginning.

Next, in step S122, RF parameters of the inductor device are inputted, such as an inductance, an operating frequency, a corresponding Q factor, and an area limitation. Thus, the system can proceed with calculation based on the inputted type information of the inductor and the RF parameters to obtain a corresponding frequency response result.

The frequency response result can be, for example, the inductance in response to the operating frequency and the Q factor in response to the operating frequency. Next, in S124, the frequency response result is outputted for the designers. Accordingly, the designers can determine whether the inputted parameter satisfies the requirements of an IC layout and meets the required specifications.

In step S126, when the outputted result in step S124 meets the required specifications, the aforesaid process is finished. On the other hand, if the outputted result in step S124 does not meet the required specifications, the process will return to step S122 to input new RF parameters and perform the aforesaid process again until a result meeting the required specifications is obtained.

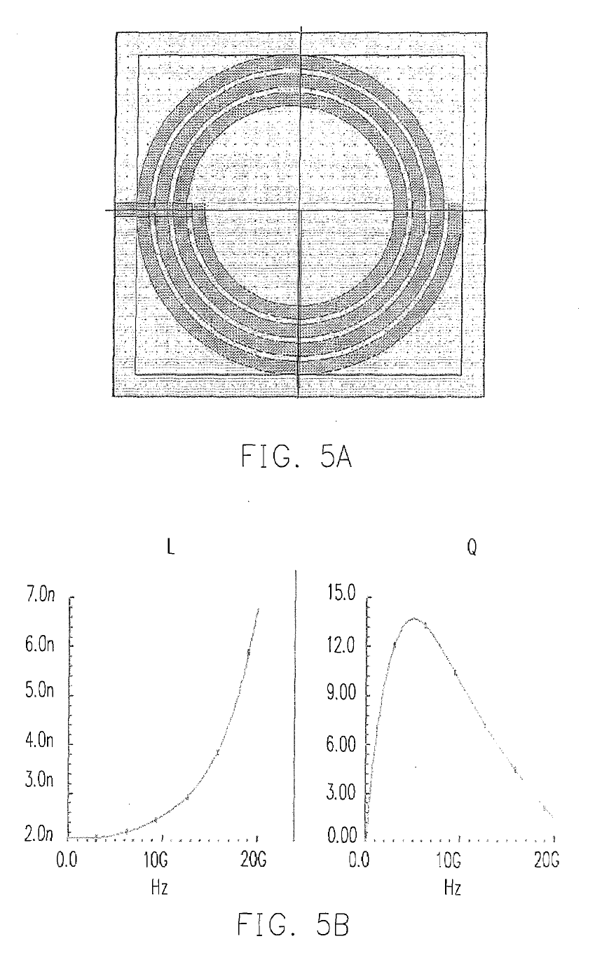

FIGS. 5A and 5B are examples of FIG. 4, wherein FIG. 4A is a top view illustrating an inductor device, and FIG. 4B is a diagram depicting a frequency response of the inductor device. In the embodiment, some geometric parameters regarding the inductor device are inputted first, such as shape, symmetric type or stacked type. Next, characteristic parameters of the inductor are inputted, such as an inductance of 2.14 nH, an operating frequency Freq of 5 GHz, and a Q factor.

After the process of inputting, the system performs the calculation process and a result is outputted. For example, in FIG. 5A, the inductor structure is a symmetric spiral shape. In FIG. 5B, the frequency response diagrams of inductance vs. frequency (L vs. Freq) and Q factor vs. frequency (Q vs. Freq) are respectively shown. The outputted result can help determine whether the required specifications are satisfied. If the result does not meet the required specifications, the parameter is changed in the process of FIG. 4 to input a parameter and perform the process again.

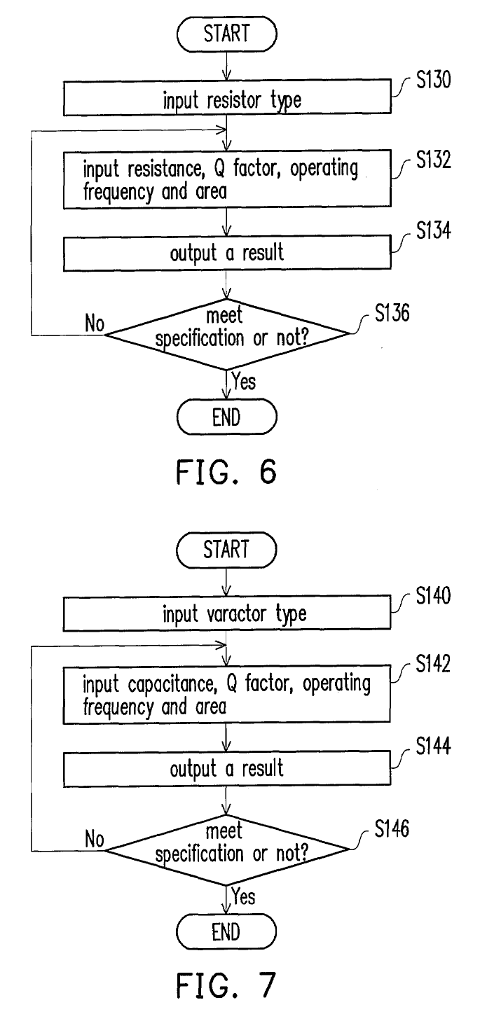

FIG. 6 is a schematic flow chart showing a layout method according to a resistor device as the embodiment of the present invention. Basically, the resistor does not belong to an RF device. But, the resistor is usually put together with a capacitor and/or an inductor to form an RC, RL, or RLC circuit. Accordingly, when designing a layout of the resistor, not only an area and an arrangement should be taken into consideration, but an effect of a particular operating frequency should be concerned.

In step S130, when designers input type information of the resistor, the type information can be type information of a doped region and a diffusion region. For example, an N-type doped polysilicon, a doped polysilicon, a high-resistance polysilicon, or an N-type diffusion region are inputted. Through the above information, the parameters concerning a position and a size of the resistor can be confirmed. In step S132, an operating frequency, a resistance under the operating frequency, and an area limitation are further inputted by the designers. Through the aforementioned two steps, a corresponding frequency response result can be calculated. Next, in step S134, a result is outputted for the designers. In step S136, based on the outputted result in step S134, the designers determine whether the result meets the required specification. When the result meets the required specifications, the process is finished. If the result does not meet the required specifications, the process will return to step S132 to input parameters again.

FIG. 7 is a schematic flow chart showing a layout method according to a varactor device as the embodiment of the present invention. A varactor is a variable capacitor whose capacitance can be adjusted. The variable capacitor uses the non-linear dielectric characteristic to dramatically reduce the dielectric constant due to the increase of bias, and can be used for adjusting voltages.

As for the varactor, the steps are similar to the process described above. First, in step S140, type information of the varactor is inputted by designers, such as a N+/N well doped type of a core region and a N+/N well doped type of an input/output region. In step S142, parameters such as a varactor value, a Q factor, an operating frequency and an area limitation are inputted.

In step S144, according to the parameters inputted in the aforesaid two steps, a corresponding frequency response result is calculated and outputted by the system. After the result is obtained by the designers, whether the result satisfies the requirements can be determined. When the result meets the required specification, the process is finished. If the result does not meet the required specifications, the process will return to step S142 to input RF parameters again.

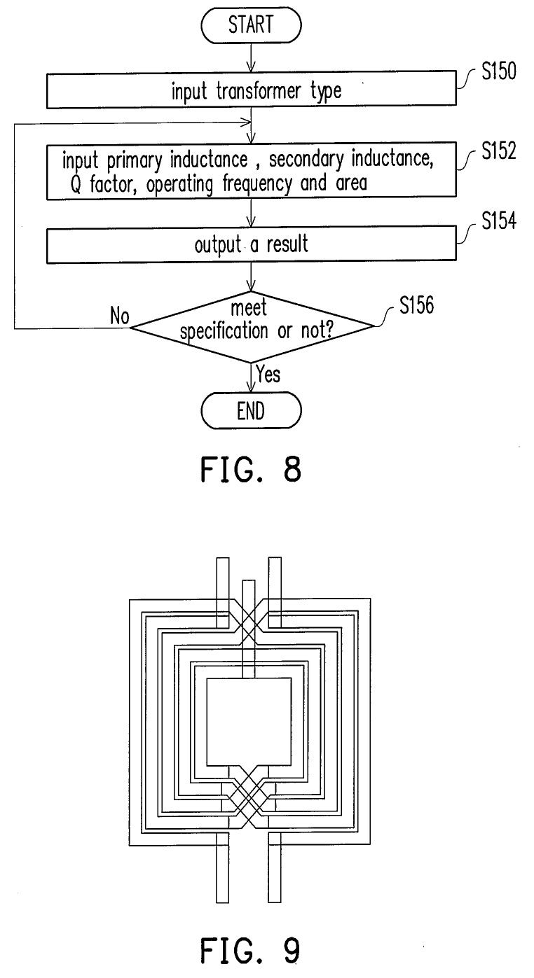

FIG. 8 is a schematic flow chart showing a layout method according to a transformer device as the embodiment of the present invention. FIG. 9 is an example of FIG. 8, and is a top view of the transformer device. In step S152, designers input type information of the transformer, and then further input RF parameters of the transformer, such as a primary inductance Lp, a secondary inductance Ls, an operating frequency, and a corresponding Q factor (or a ratio of the primary Q factor to the secondary Q factor). The transformer type can be, for example, a turn ratio, an area limitation, an insert loss, and a coupling constant (1), etc. Thus, the system can proceed with calculation based on the inputted type information of the transformer and the RF parameters to obtain a corresponding frequency response result. For example, the inputted parameter can be that inductance Lp/Ls is 2.15 nH/0.9 nH, the Q factor is 7 or more, the operational frequency F is 2.4 GHz, and the transformer is a single-differential type.

The frequency response result can be, for example, the transformer in response to the operating frequency and the Q factor in response to the operating frequency. In addition, the system can also output turns of primary wires and secondary wires, an outer diameter, a width and a pitch between metal layers. Then, in step S154, the frequency response result is outputted for the designers. Accordingly, the designers can determine whether the inputted parameter satisfies the requirements of an IC layout and meets the required specifications.

In step S156, when the outputted result in step S154 meets the required specifications, the aforesaid process is finished. On the other hand, if the outputted result in step S154 does not meet the required specifications, the process will return to step S152 to input new RF parameters and perform the aforesaid process again until a result meeting the required specifications is obtained. For example, above inputted parameters can generate an optimized transformer layer as shown in FIG. 9, in which the optimized output parameters are that the outer diameter is 150 cm, the primary/second turn number is ⅔, the primary/secondary Q factor ratio Qp/Qs is 9.6/8.4, the primary/secondary inductance Lp/Ls is 2.15 nH/0.92 nH, and the turn ratio is 1.53, etc.

In each of the aforementioned embodiments, in order to explain briefly, the individual RF device or a device operated under the RF is taken as an example. However, in practice, the IC layout is not limited only to the single type described above. In IC layout, an RC circuit, an RL circuit, and an RLC circuit are usually included, that is, a circuit configuration in combination of capacitors, inductors, and resistors. The layout method of the present invention can be applied to the combined circuit configuration comprising capacitors, inductors, resistors, and other devices mentioned above.

Besides, the application of the present invention is not limited to the above embodiments, that is, the application is not limited to capacitor, inductor, resistor, and varactor. The layout method of the present invention can be utilized, provided that the layout is applied in the RF range.

Furthermore, descriptions of the above-mentioned embodiments focus on the layout process for the RF device. The method of the present invention can be combined with the general layout method. In other words, all the device parameters (including the RF device and the non-RF device) are inputted in the beginning. Afterwards, the devices are grouped and arranged on a region where an IC layout will be formed. The portion belongs to the conventional art and will not be explained here. It should be emphasized that any layout method can be operated in coordination with the layout method of the RF device of the present invention.

Accordingly, based on the disclosure of the present invention, a preferred device search database concerning the RF device is provided. Therefore, time for designers to design the layout diagram can be reduced. Through inputting the parameters of the RF device such as an operating frequency, a Q factor, and an area limitation, an optimized device dimension and a layout design can be obtained. According to the disclosure of the present invention, designers do not require to perform a testing of a frequency response in the layout process, whereas a simulation is carried out by designers in advance in order to perform the layout process only when the required specifications are satisfied. Therefore, time for designers to design a layout diagram can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for producing a layout of an integrated circuit with radio frequency (RF) devices, comprising steps of:
inputting type information of at least one RF device;
inputting at least one RF parameter corresponding to the RF device;
generating a frequency response result based on the RF parameter and the type information;
performing an IC layout process as the frequency response result meets a required specification; and
inputting another RF parameter again as the frequency response result does not meet the required specification.

2. The method of claim 1, wherein the RF parameter comprises a device value, an operating frequency, a Q factor, and a combination thereof.

3. The method of claim 1, wherein the RF device comprises a capacitor device, an inductor device, a varactor device, a resistor device, a transistor, a transformer and a combination thereof.

4. The method of claim 1, wherein the type information comprises a geometric parameter of the RF device in the integrated circuit.

5. The method of claim 2, wherein the frequency response result comprises at least a diagram depicting the RF device value in response to the operating frequency and a diagram depicting the Q factor in response to the operating frequency.

6. The method of claim 1, wherein the RF device is a capacitor device, and the type information of the capacitor device comprises at least information of a stacked type of metal layers, a number of the stacked type, a number of fingers of the metal layer, and a length and a width of the finger.

7. The method of claim 1, wherein the RF device is an inductor device, and the type information of the inductor device comprises at least a geometrical shape, a geometric dimension, a symmetric relation, and stacked type information.

8. The method of claim 1, wherein the RF device is a resistor device, and the type information of the resistor device comprises at least type information of a doped region and of a diffusion region.

9. The method of claim 1, wherein the RF device is a varactor device, and the type information of the varactor device comprises at least type information of a core doped region and of an input/output doped region.

10. The method of claim 1, wherein the RF device is a transformer device, and the RF parameter of the transformer device comprises at least a primary inductance, a secondary inductance, a Q factor and an operating frequency.

11. A method for producing a layout of an integrated circuit, comprising the following steps:
inputting a plurality of devices; grouping the devices and disposing the grouped devices on a predetermined region for forming an integrated circuit (IC), wherein the devices comprise a plurality of radio frequency (RF) devices and of non-RF devices;
inputting device type information corresponding to each of the devices;
inputting at least one RF parameter corresponding to each of the RF devices;
generating a frequency response result based on the RF parameter and the device type information of the RF devices;
performing an IC layout process as the frequency response result meets the required specification; and
changing the RF parameter as the frequency response result does not meet the required specification and calculating a frequency response result again until the result meets the required specification.

12. The method of claim 11, wherein the RF parameter comprises a device value, an operating frequency, a Q factor, and a combination thereof.

13. The method of claim 11, wherein the RF device comprises a capacitor device, an inductor device, a varactor device, a resistor device, a transistor, a transformer and a combination thereof.

14. The method of claim 11, wherein the type information comprises a geometric parameter of the RF device in the integrated circuit.

15. The method of claim 12, wherein the frequency response result comprises at least a diagram depicting the RF device value in response to the operating frequency and a diagram depicting the Q factor in response to the operating frequency.

16. The method of claim 11, wherein the RF device is a capacitor device, and the type information of the capacitor device at least comprises information of a stacked type of metal layers, a number of the stacked type, a number of fingers of the metal layer, and a length and a width of the finger.

17. The method of claim 11, wherein the RF device is an inductor device, and the type information comprises at least a geometrical shape, a geometric dimension, a symmetric relation, and stacked type information.

18. The method of claim 11, wherein the RF device is a resistor device, and the type information of the resistor comprises at least type information of a doped region and of a diffusion region.

19. The method of claim 11, wherein the RF device is a varactor device, and the type information of the varactor device comprises at least type information of a core doped region and of an input/output doped region.

20. The method of claim 11, wherein the RF device is a transformer device, and the RF parameter of the transformer device comprises at least a primary inductance, a secondary inductance, a Q factor and an operating frequency.
